(19) United States
(12) Patent Application Publication
(10) Pub. No.: US 2024/0312093 A1
(43) Pub. Date: Sep. 19, 2024

(54) Rendering Avatar to Have Viseme Corresponding to Phoneme Within Detected Speech

(71) Applicant: Hewlett-Packard Development Company, L.P., Spring, TX (US)

(72) Inventors: Rafael Ballagas, Palo Alto, CA (US); Jishang Wei, Fort Collins, CO (US)

(21) Appl. No.: 18/576,647

(22) PCT Filed: Jul. 15, 2021
(86) PCT No.: PCT/US2021/041822

§ 371 Date: Jan. 4, 2024

(51) Int. Cl. G06T 13/20; G06T 13/40

(52) U.S. Cl. CPC G06T 13/205; G06T 13/40

(57) ABSTRACT

Speech is detected using a microphone of a head-mountable display (HMD). The speech includes a phoneme. Whether a wearer of the HMD uttered the speech is determined. In response to determining that the wearer uttered the speech, an avatar representing the wearer is rendered to have a viseme corresponding to the phoneme.

### BACKGROUND

Speech animation is the process of moving the facial features of an avatar during rendering to synchronize lip motion of the avatar to spoken audio to give the impression that the avatar is uttering the speech. An avatar is a graphical representation of a user or the user's persona, may be in three-dimensional (3D) form, and may have varying degrees of realism, from cartoonish to nearly lifelike. Uttered speech is made up of phonemes, which are perceptually distinct units of sound within speech. In speech animation, an avatar is rendered so that its facial features include visemes corresponding to the phonemes of the detected speech. Visemes are the visible mouth shapes of phonemes to which they correspond.

### BRIEF DESCRIPTION OF THE DRAWINGS

FIGS. 1A and 1B are perspective and front view diagrams, respectively, of an example head-mountable display (HMD).

FIGS. 2A and 2B are diagrams illustratively depicting example avatar rendering to include or not include a viseme corresponding to a phoneme within detected speech based on whether a wearer of an HMD uttered the speech, as determined by detecting mouth movement within facial images of the wearer captured by a camera of the HMD.

FIG. 3 is a top view diagram illustratively depicting example determination of whether an HMD wearer has uttered detected speech using a microphone array of the HMD.

FIG. 4 is a diagram of an example process for rendering an avatar to include or not include a viseme corresponding to a phoneme within detected speech based on whether a wearer of an HMD uttered the speech.

FIG. 5 is a diagram of an example process for generally rendering an avatar to include a viseme corresponding to a phoneme within detected speech based on the phoneme, captured facial images of a wearer of an HMD, and/or sensor values received from other sensors of the HMD.

FIGS. 6, 7, and 8 are diagrams of different example processes for specifically rendering an avatar to include a viseme corresponding to a phoneme within detected speech based on the phoneme identified within the speech and captured facial images of a wearer of an HMD.

FIG. 9 is a diagram of an example non-transitory computer-readable data storage medium storing program code.

FIG. 10 is a flowchart of an example method.

FIG. 11 is a block diagram of an example HMD.

### DETAILED DESCRIPTION

As noted in the background, in speech animation an avatar is rendered to have visemes corresponding to phonemes within detected speech, to give the impression that the avatar is uttering the speech. Speech animation can be used in conjunction with extended reality (XR) technologies. XR technologies virtual reality (VR), augmented reality (AR), and mixed reality (MR) technologies, and which quite literally extend the reality that users experience.

XR technologies may employ head-mountable displays (HMDs). An HMD is a display device that can be worn on the head. In VR technologies, the HMD wearer is immersed in an entirely virtual world, whereas in AR technologies, the HMD wearer's direct or indirect view of the physical, real-world environment is augmented. In MR, or hybrid reality, technologies, the HMD wearer experiences the merging of real and virtual worlds.

An HMD can include one or multiple small display panels in front of the wearer's eyes, as well as various sensors to detect or sense the wearer and/or the wearer's environment. Images on the display panels convincingly immerse the wearer within an XR environment. An HMD can include one or multiple microphones to detect speech uttered by the wearer as well as other sound, and can include one or multiple speakers, such as in the form of a headset, to output audio to the wearer.

An HMD can include one or multiple cameras, which are image-capturing devices that capture still or motion images. For example, one camera of an HMD may be employed to capture images of the wearer's lower face, including the mouth. Two other cameras of the HMD may be each be employed to capture images of a respective eye of the HMD wearer and a portion of the wearer's face surrounding the eye. An HMD can also include other sensors, such as facial electromyographic (fEMG) sensors. fEMG sensors output signals that measure facial muscle activity by detecting and amplifying small electrical impulses that muscle fibers generate when they contract.

In the context of speech animation, an avatar representing a wearer of an HMD may be rendered to have visemes corresponding to speech detected by a microphone of the HMD. If the HMD wearer is participating in an XR environment with other users wearing their own HMDs, the avatar representing the HMD wearer may be displayed on the HMDs of these other users. Rendering of the avatar to have visemes corresponding to speech detected by the HMD of the wearer to which the avatar corresponds results in the other users viewing the avatar on their own HMDs as if the avatar were uttering the speech spoken by the wearer.

However, the wearer of the HMD may be located in an environment in which other people may be speaking. The microphone of the wearer's HMD may detect such speech of people other than the wearer him or herself. As a result, the avatar representing the wearer may be rendered to have visemes corresponding to the phonemes of the detected speech, even though the wearer did not actually utter the speech.

Techniques described herein render an avatar to have visemes corresponding to phonemes within speech detected by a microphone of an HMD just if the wearer of the HMD is determined as having actually uttered the speech. If the wearer did not utter the detected speech, then the avatar is not rendered to have visemes corresponding to the phonemes within the speech. The avatar is therefore more accurately rendered to more closely mimic the wearer.

Whether the HMD wearer has uttered the speech detected by the microphone of the HMD can be determined in a number of different ways. For example, mouth movement of the HMD wearer may be detected, such as based on facial images of the wearer captured by a camera of the HMD or based on sensor data received from fEMG or other sensors of the HMD. If mouth movement of the wearer occurred while the speech was detected, then it can be concluded that the wearer uttered the speech.

As another example, the microphone of the HMD may be a microphone array that provides the direction from which the detected speech originated. If the speech was uttered from the direction of the HMD wearer's mouth, then it can be concluded that the wearer uttered the speech. In these and other example implementations, therefore, information provided by the HMD can be used to ascertain whether the wearer uttered the detected speech.

However, the techniques described herein can also be applied to non-HMD contexts. For example, the techniques may be applied in conjunction with computing devices like desktop, laptop, and notebook computers, smartphones, and other computing devices like tablet computing devices. In such cases, whether speech detected by an internal or external microphone of the computing device was uttered by a user of the computing device is determined based on information provided by the microphone, by an internal or external camera such as a webcam, or by another type of sensor.

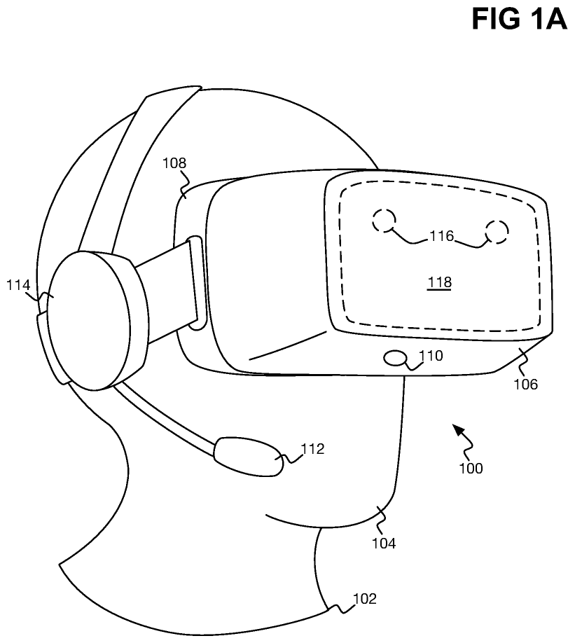

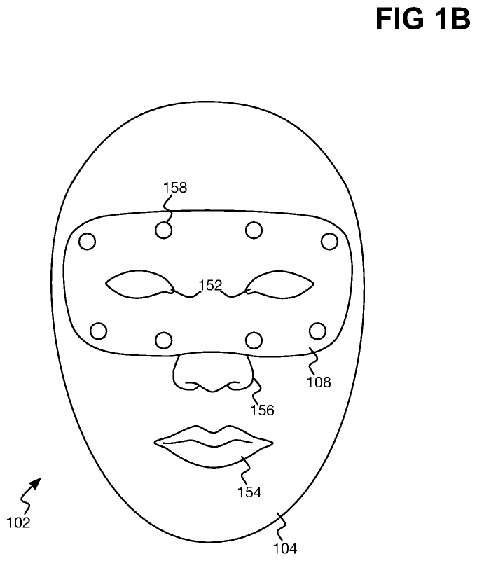

FIGS. 1A and 1B show perspective and front view diagrams of an example HMD 100 worn by a wearer 102 and positioned against the face 104 of the wearer 102. The HMD 100 includes a main body 106 having a gasket 108 at one end of the body 106 that is positionable against the wearer 102's face 104 above the nose 156 and around the eyes 152 of the wearer 102 (per FIG. 1B). The gasket 108 may be fabricated from a soft flexible material, such as rubberized foam, that can deform in correspondence with contours of the wearer 102's face 104 to block ambient light from entering the interior of the main body 106 at the interface between the gasket 108 and the face 104 of the wearer 102. The gasket 108 further promotes wearer 102 comfort in usage of the HMD 100, since unlike the gasket 108 the main body 106 itself may be fabricated from a rigid material such as plastic and/or metal.

The HMD 100 can include a display panel 118 inside the other end of the main body 106 that is positionable incident to the eyes 152 of the wearer 102. The display panel 118 may in actuality include a right display panel incident to and viewable by the wearer 102's right eye 152, and a left display panel incident to and viewable by the wearer's 102 left eye 152. By suitably displaying images on the display panel 118, the HMD 100 can immerse the wearer 102 within an XR.

The HMD 100 can include eye camera 116 and/or a mouth camera 110. While just one mouth camera 110 is shown, there may be multiple mouth cameras 110. Similarly, whereas just one eye camera 116 for each eye 152 of the wearer 102 is shown, there may be multiple eye cameras 116 for each eye 152. The cameras 110 and 116 capture images of different portions of the face 104 of the wearer 102 of the HMD 100.

The eye cameras 116 are inside the main body 106 of the HMD 100 and are directed towards respective eyes 152. The right eye camera 116 captures images of the facial portion including and around the wearer 102's right eye 152, whereas the left eye camera 116 captures images of the facial portion including and around the wearer 102's left eye 152. The mouth camera 110 is exposed at the outside of the body 106 of the HMD 100, and is directed towards the mouth 154 of the wearer 102 (per FIG. 1B) to capture images of a lower facial portion including and around the wearer 102's mouth 154.

The HMD 100 can include a microphone 112 positionable in front of the wearer 102's lower face 104, near or in front of the mouth 154 of the wearer 102. The microphone 112 detects sound within the vicinity of the HMD 100, such as speech uttered by the wearer 102. While one microphone 112 is shown, there may be more than one microphone 112. The microphone 112 may be a single-channel microphone, a dual-channel (i.e., stereo) microphone, or another type of microphone. For instance, the microphone 112 may be a microphone array, permitting the direction from which detected sound originated to be identified.

The HMD 100 can include one or multiple speakers 114. The speakers 114 may be in the form of a headset as shown. There may be a speaker 114 over each ear of the wearer 102 of the HMD 100 for the outputting of stereo sound. However, there may just be one speaker 114 positionable over a corresponding ear of the wearer 102, in which case monoaural sound is output.

The HMD 100 can include fEMG sensors 158 (per FIG. 1B). The fEMG sensors 158 are disposed within the gasket 108. The fEMG sensors 158 are externally exposed at the gasket 108, so that the sensors 158 come into contact with the skin of the wearer 102's face 104 when the HMD 100 is worn by the wearer 102. The number and positions of the fEMG sensors 158 can differ from that which is shown. The FEMG sensors 158 output signals measuring facial muscle activity of the wearer 102 of the HMD 100.

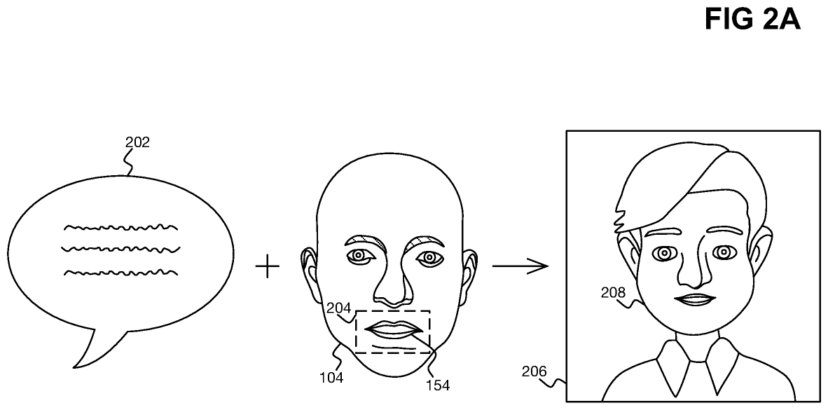

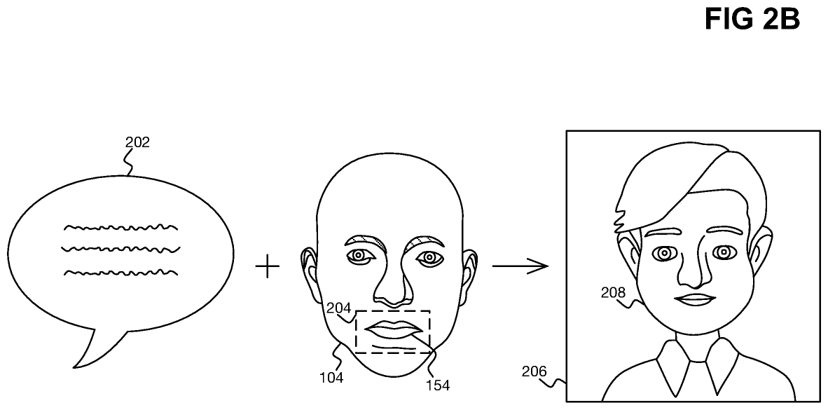

FIGS. 2A and 2B show an example as to how an avatar 208 representing the HMD wearer 102 is differently rendered based on whether the wearer 102 has uttered the detected speech 202. In both figures, the microphone 112 of the HMD 100 detects speech 202, which includes one or multiple phonemes. Furthermore, the mouth camera 110 of the HMD 100 captures a lower facial image 204 of the wearer 102's face 104 while the speech 202 is detected.

In FIG. 2A, mouth movement of the wearer 102 does not occur, as detected from the facial image 204 captured by the camera 110. Therefore, the avatar 208 representing the wearer 102 is rendered and an image 206 of the rendered avatar 208 can be displayed such that the avatar 208 does not give the impression that the avatar 208 is uttering the detected speech 202. That is, the avatar 208 is rendered to not have visemes corresponding to the phonemes of the detected speech 202.

In FIG. 2B, by comparison, mouth movement of the wearer 102 does occur, as detected from the facial image 204 captured by the camera 110. Therefore, the avatar 208 representing the wearer 102 is rendered and an image 206 of the rendered avatar 208 can be displayed such that the avatar 208 does give the impression that the avatar 208 is uttering the detected speech 202. That is, the avatar 208 is rendered to have visemes corresponding to the phonemes of the detected speech 202.

In both figures, speech 202 is detected by the microphone 112 of the HMD 100. However, whether the wearer 102 of the HMD 100 has uttered the speech 202 governs whether the avatar 208 corresponding to the wearer 102 of the HMD 100 is rendered to include visemes corresponding to phonemes within the speech 202. FIGS. 2A and 2B show that whether the wearer 102 has uttered the detected speech 202 can be determined by detecting whether mouth movement of the wearer 102 occurred while the speech 202 was detected.

In the example, detecting whether mouth movement of the wearer 102 occurred while the speech 202 was detected is achieved by using the mouth camera 110 of the HMD 100. The mouth camera 110 captures a lower facial image 204 of the wearer 102 from which whether the wearer 102 is moving his or her mouth 154 or not can be identified. However, whether mouth movement of the wearer 102 occurred while the speech 202 was detected, in order to determine whether the wearer 102 uttered the detected speech 202, can be determined in other ways as well.

For instance, the fEMG sensors 158 of the HMD 100 can be used to detect mouth movement of the wearer 102 while the speech 202 was detected. Facial muscles of the wearer 102 contract and expand as the wearer 102 is opening and closing his or her mouth 154. Because the fEMG sensor 158 can detect facial muscle movement, whether such facial muscle movement corresponds to mouth movement of the wearer 102 can therefore be determined in order to determine whether the wearer 102 uttered the detected speech 202.

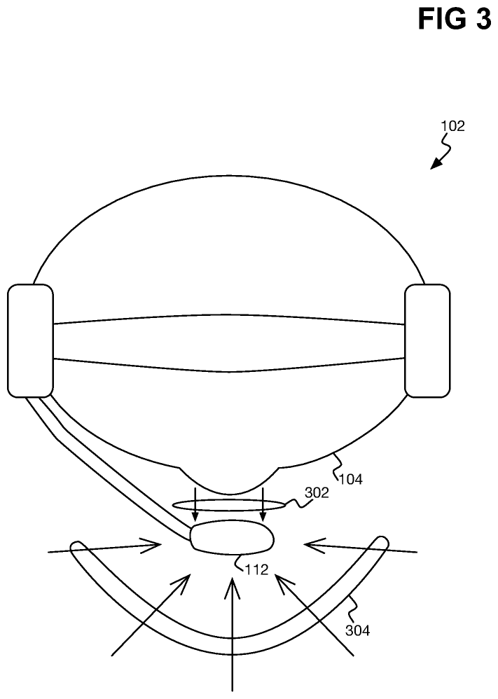

FIG. 3 shows an example as to how the microphone 112 of the HMD 100 can itself be used to determine whether the wearer 102 of the HMD 100 has uttered the speech detected by the microphone 112. In the example, the microphone 112 is specifically a microphone array that can identify the direction from which detected sound, including speech, originated. The microphone 112 is positioned in front of the wearer 102's face 104, as noted above, such as near or in front of the mouth 154 of the wearer 102.

Therefore, if speech detected by the microphone 112 is detected from the direction of the wearer 102's mouth 154 per arrows 302, then the wearer 102 of the HMD 100 is determined as having uttered the speech. By comparison, if the speech detected by the microphone 112 is detected from any other direction, such as in front of or to either side of the wearer 102 per arrows 304, then the wearer 102 is determined as not having uttered the speech. An avatar 208 representing the wearer 102 is accordingly rendered to have or not have visemes corresponding to phonemes within the detected speech based on this determination.

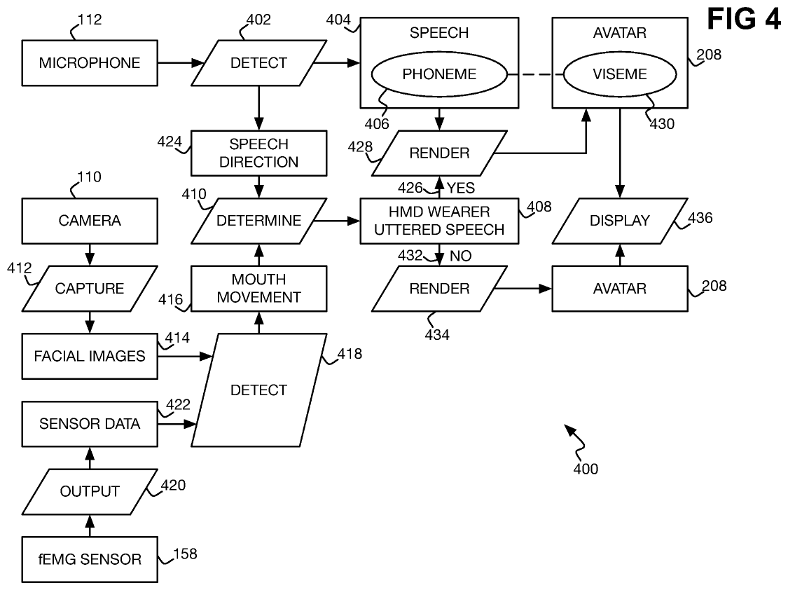

FIG. 4 shows an example process 400 for rendering an avatar 208 to include or not include visemes corresponding to phonemes within detected speech. The microphone 112 of the HMD 100 detects (402) speech 404 including a phoneme 406. Whether the wearer 102 of the HMD 100 uttered the speech 404 (408) is determined (410). As noted, whether the HMD wearer 102 uttered the speech 404 detected by the microphone 112 can be determined in a number of different ways.

First, whether mouth movement 416 of the wearer 102 occurred while the speech 404 was detected can be detected (418). For instance, the mouth camera 110 of the HMD 100 can capture (412) facial images 414 on which basis such mouth movement 416 can be detected. As another example, an fEMG sensor 158 or other sensor can output (420) sensor data 422 on which basis mouth movement of the wearer 102 of the HMD 100 can be detected. Mouth movement 416 may also be detected on the basis of both the captured facial images 414 and the received sensor data 422.

Second, as part of the detection of the speech 404, the microphone 112 may provide information indicative of the direction 424 of the speech 404, such as if the microphone 112 is a microphone array. Whether the wearer 102 uttered the speech 404 (408) can thus be determined (410) on the basis of the direction 424 of the speech 404 and/or the on the basis of whether mouth movement 416 of the wearer 102 was detected. That is, whether the wearer 102 uttered the speech 404 can be determined based on just the speech direction 424, based on just whether mouth movement 416 was detected, or based on both.

If the HMD wearer 102 is determined to have uttered the speech 404 detected by the microphone 112 (426), then the avatar 208 representing the wearer 102 is rendered (428) to include a viseme 430 corresponding to the phoneme 406 of the detected speech 404. The avatar 208 may be rendered using speech animation techniques that consider just the detected speech 404 itself. However, the avatar 208 may also be rendered in consideration of the captured facial images 414 and/or the received sensor data 422, as described later in the detailed description.

If the HMD wearer 102 is determined to have not uttered the speech 404 detected by the microphone 112 (432), then the avatar 208 representing the wearer 102 is rendered (434) to not include any viseme corresponding to the phoneme 406 of the detected speech 404. Therefore, the avatar 208 more accurately represents the wearer 102 of the HMD 100: the avatar 208 is rendered to give the impression that it is uttering the speech 404 just if the wearer 102 uttered the speech 404. The rendered avatar 208 can then be displayed (436).

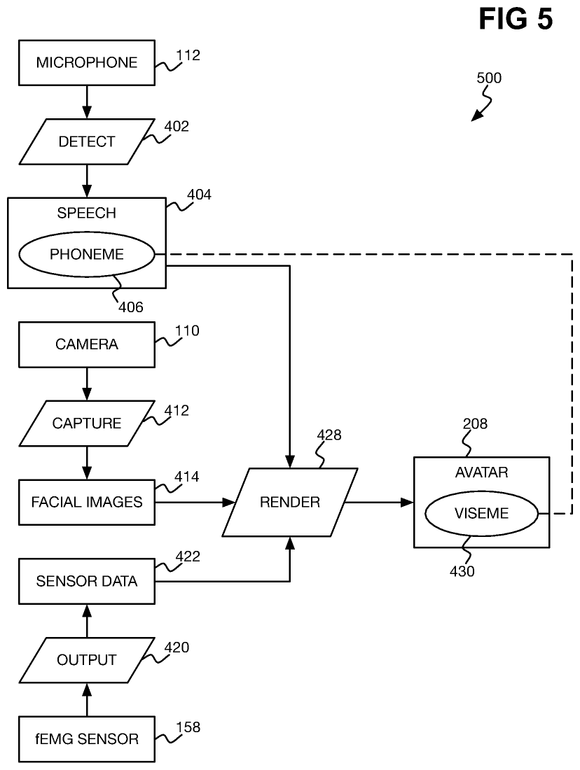

FIG. 5 shows an example process 500 for rendering the avatar 208 to have a viseme 430 corresponding to the phoneme 406 within detected speech 404 in such a way to leverage the information provided by the HMD 100 on which basis the wearer 102 was determined as having uttered the speech 404. As noted, speech animation techniques can render the avatar 208 to have the viseme 430 based on just the detected speech 404 itself (e.g., such as based on just the viseme 430 identified within the speech 404). The process 400 that has been described performs such rendering just if the wearer 102 has been determined as having uttered the speech 404. The process 500 also uses the information on which basis the wearer 102 was determined as having uttered the speech 404 for avatar 208 rendering purposes.

In the example, it is assumed that the wearer 102 of the HMD 100 has uttered the speech 404 detected (402) by the microphone 112 of the HMD 100. That the wearer 102 uttered the speech 404 may have been determined on the basis of facial images 414 captured (412) by the mouth camera 110 of the HMD 100. Additionally or instead, that the wearer 102 uttered the speech 404 may have been determined on the basis of sensor data 422 output (420) by an fEMG sensor 158 or other sensor of the HMD 100.

The avatar 208 is therefore rendered (428) to have a viseme 430 corresponding to the phoneme 406 within the detected speech 404 based on the speech 404 itself, as well as on the captured facial images 414 of the HMD wearer 102 and/or the received sensor data 422. If just the captured facial images 414 or just the received sensor data 422 is available, then the avatar 428 is rendered (428) to have the viseme 430 based on the speech 404 and the facial images 414 or sensor data 422 that is available. If both the facial images 414 and the sensor data 422 are available, then the avatar 428 is rendered (428) to have the viseme 430 based on the speech 404 and both the captured facial images 414 and the received sensor data 422.

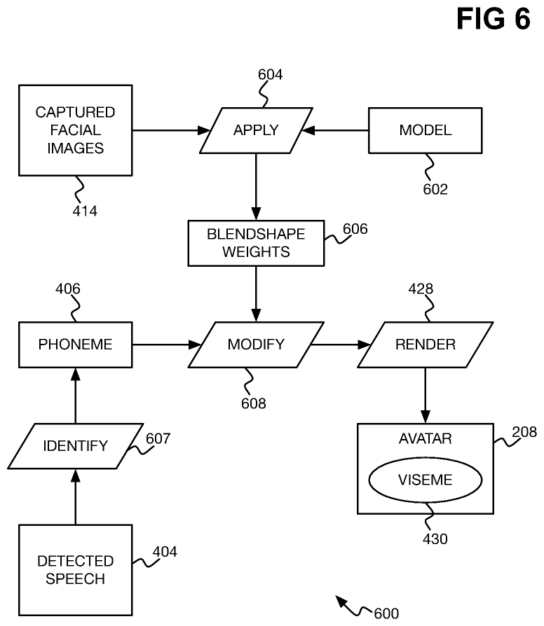

FIG. 6 shows an example process 600 for rendering the avatar 208 to have a viseme 430 corresponding to the phoneme 406 within detected speech 404 based on the speech 404 and based on the captured facial images 414 of the wearer 102 on which basis the wearer 102 may have been determined as having uttered the speech 404. In the example, a model 602 is applied (604) to the captured facial images 414 to generate blendshape weights 606. The model 602 may be a previously trained machine learning model, for instance.

The blendshapes may also be referred to as facial action units and/or descriptors, and the values or weights may also be referred to as intensities. Individual blendshapes can correspond to particular contractions or relaxations of one or more muscles, for instance. Any anatomically possible facial expression can thus be deconstructed into or coded as a set of blendshape weights representing the facial expression. The blendshapes may be defined by a facial action coding system (FACS) that taxonomizes human facial movements by their appearance on the face, via weights for different blendshapes.

The phoneme 406 within the detected speech 404 is identified (607). For example, a different machine learning model, or another speech animation technique, may be applied to the detected speech 404 to identify the phoneme 406. The blendshape weights 606 generated from the captured facial images 414 are then modified (608) based on the identified phoneme 406 so that the facial expression characterized by these weights better reflect the actual phoneme 406 within the detected speech 404. For example, the blendshape weights 606 corresponding to mouth movement may be adjusted based on the actual phoneme 406 that has been identified.

The avatar 208 representing the HMD wearer 102 is then rendered (428) from the resultantly modified blendshape weights 606. In general, an avatar 208 can be rendered to have a particular facial expression based on the blendshape weights 606 of that facial expression. That is, specifying the blendshape weights 606 for a particular facial expression allows for the avatar 208 to be rendered to have the facial expression in question.

The process 600 thus initially generates the blendshape weights 606 on which basis the avatar 208 is rendered from the captured facial images 414 of the wearer 102. However, because the avatar 208 is to give the impression of uttering the detected speech 404 having the phoneme 406, such blendshape weights 606 can be modified once this phoneme 406 has been identified to render the avatar 208 more realistically in this respect. Therefore, the rendered avatar 208 has a facial expression corresponding to the wearer 102 within the captured facial images 414, and specifically includes the viseme 430 corresponding to the phoneme 406 within the detected speech 404.

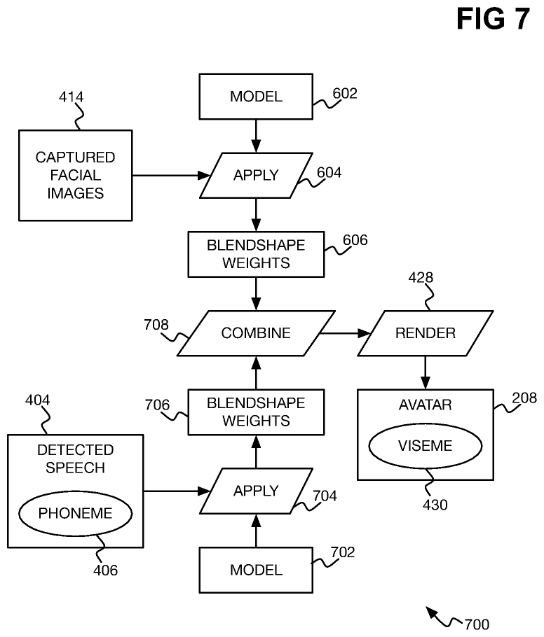

FIG. 7 shows another example process 700 for rendering the avatar 208 to have a viseme 430 corresponding to the phoneme 406 within detected speech 404 based on the speech 404 and based on the captured facial images 414 of the wearer 102 on which basis the wearer 102 may have been determined as having uttered the speech 404. As in the process 500, in the process 600, a model 602 is applied (604) to the captured facial images 414 to generate (first) blendshape weights 606.

Another model 702 is applied (704) to the detected speech 404 to generate (second) blendshape weights 706. The model 702 may also be a previously trained machine learning model. The blendshapes weights 606 characterize the facial expression of the wearer 102 of the HMD 100 as captured within the facial images 414, whereas the blendshape weights 706 characterize the facial expression of the wearer 102 in terms of the phoneme 406 and other information within the detected speech 404. The blendshape weights 706 may reflect just mouth movement corresponding to the phoneme 406, for instance, whereas the blendshape weights 606 may reflect the overall facial expression of the wearer 102 as a whole.

The blendshape weights 706 may be more accurate in characterizing mouth movement corresponding to the actual phoneme 406 within the detected speech 404 than the blendshape weights 606 do. Therefore, the blendshape weights 606 and 706 can be combined (708), with the avatar 208 rendered (428) to have a facial expression including the viseme 430 corresponding to the phoneme 406 within the detected speech 404 on the basis of the combined blendshapes that have been yielded. The process 700 thus generates blendshape weights 606 and 706 from the facial images 414 and the speech 404, respectively, which are then combined for rendering the avatar 208. By comparison, the process 600 generates blendshape weights 606 from the facial images 414, which are then modified based on the identified phoneme 406 within the speech 404 prior to rendering the avatar 208.

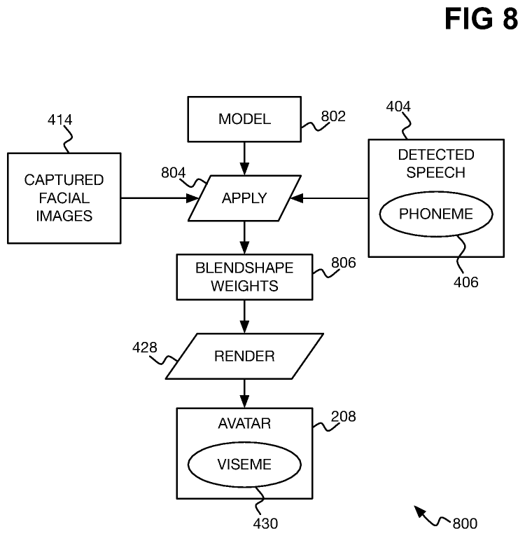

FIG. 8 shows a third example process 800 for rendering the avatar 208 to have a viseme 430 corresponding to the phoneme 406 within detected speech 404 based on the speech 404 and based on the captured facial images 414 of the wearer 102 on which basis the wearer 102 may have been determined as having uttered the speech 404. A model 802 is applied (804) to both the captured facial images 414 and the detected speech 404 to generate blendshape weights 806 corresponding to the facial expression of the wearer 102 within the captured images 414 with mouth movement corresponding to the phoneme 406 within the detected speech 404. The model 802 may be a previously trained machine learning model, for instance.

The avatar 208 is then rendered (428) from the generated blendshape weights 806 to have the facial expression of the wearer 102 including the viseme 430 corresponding to the phoneme 406 within the detected speech 404. The process 800 thus inputs both the captured facial images 414 and the detected speech 404 into one model 802, with the model 802 generating the blendshape weights 806 in consideration of both the facial images 414 and the detected speech 404. By comparison, the process 700 respectively applies separate models 602 and 702 to the facial images 414 and the speech 404 to generate corresponding blendshape weights 606 and 706 that are combined for rendering the avatar 208 representing the wearer 102.

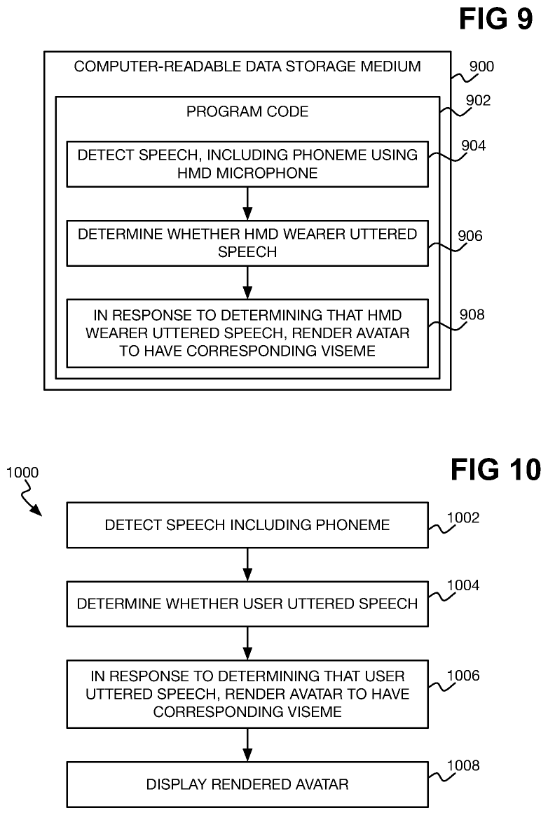

FIG. 9 shows an example non-transitory computer-readable data storage medium 900 storing program code 902 executable by a processor to perform processing. The processing includes detecting speech 404 using a microphone 112 of an HMD 100 (904). The detected speech 404 includes a phoneme 406. The processing includes determining whether a wearer 102 of the HMD 100 uttered the speech 404 (906). The processing includes, in response to determining that the wearer 102 uttered the speech 404, rendering an avatar 208 representing the wearer 102 to have a viseme 430 corresponding to the phoneme 406 (908).

The processor that executes the program code 902 may be part of a host device, such as a computing device like a computer, smartphone, and so on, to which the HMD 100 is communicatively connected. The processor may instead be part of the HMD 100 itself. The processor and the data storage medium 900 may be integrated within an application-specific integrated circuit (ASIC) in the case in which the processor is a special-purpose processor. The processor may instead be a general-purpose processor, such as a central processing unit (CPU), in which case the data storage medium 900 may be discrete from the processor. The processor and/or the data storage medium 900 may constitute circuitry.

FIG. 10 shows an example method 1000. The method 1000 may be performed by a processor, such as that of the HMD 100 or a host device to which the HMD 100 is communicatively connected. The method 1000 may be implemented as program code stored on a non-transitory computer-readable data storage medium. In such instance, the processor and the data storage medium may be integrated within an ASIC or be discrete from one another, as noted above, and may together constitute circuitry.

The method 1000 includes detecting, using a microphone 112, speech 404 including a phoneme 406 (1002), and determining whether a user, such as the wearer 102, uttered the speech 404 (1004). The method 1000 includes in response to determining that the user uttered the speech 404, rendering an avatar 208 representing the user to have a viseme 430 corresponding to the phoneme 406 (1006). The method 1000 includes displaying the avatar 208 representing the user (1008).

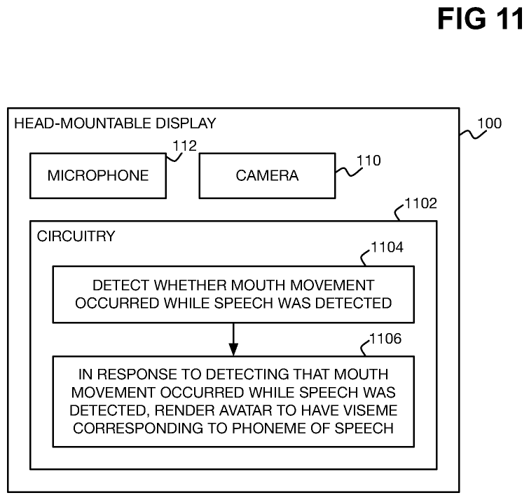

FIG. 11 shows a block diagram of the example HMD 100. The HMD 100 includes a microphone 112 to detect speech 404 including a phoneme 406. The HMD 100 includes a camera 110 to capture facial images 414 of a wearer 102 of the HMD 100 while the speech 404 is detected. The HMD 100 includes circuitry 1102. The circuitry 1102 is to detect whether mouth movement 416 of the wearer 102 occurred while the speech 404 was detected, from the captured facial images 414 (1104). The circuitry is to, in response to detecting that the mouth movement 416 of the wearer 102 occurred while the speech 404 was detected, render an avatar 208 representing the wearer 102 to have a viseme 430 corresponding to the phoneme 406 (1106).

Techniques have been described for rendering an avatar to have a viseme corresponding to a phoneme within detected speech. Whether a user uttered the speech is determined, such as by detecting whether the speech was uttered from the direction of the user's mouth, or by detecting mouth movement of the user while the speech was detected. In the latter case, mouth movement may be detected using captured facial images of the user or other received sensor data. The avatar is rendered to have the viseme corresponding to the phoneme within the detected speech just if the user is determined as having uttered the speech.

We claim:

1. A non-transitory computer-readable data storage medium storing program code executable by a processor to perform processing comprising:
detecting speech using a microphone of a head-mountable display (HMD), the speech including a phoneme;
determining whether a wearer of the HMD uttered the speech; and
in response to determining that the wearer uttered the speech, rendering an avatar representing the wearer to have a viseme corresponding to the phoneme.

2. The non-transitory computer-readable data storage medium of claim 1, wherein the processing comprises:
displaying the rendered avatar representing the wearer of the HMD.

3. The non-transitory computer-readable data storage medium of claim 1, wherein the processing comprises:
in response to determining that the wearer did not utter the speech, not rendering the avatar to have the viseme corresponding to the phoneme.

4. The non-transitory computer-readable data storage medium of claim 1, wherein determining whether the wearer of the HMD uttered the speech comprises:
detecting, using a camera of the HMD, whether mouth movement of the wearer occurred while the speech was detected;
in response to detecting that the mouth movement of the wearer occurred while the speech was detected, determining that the wearer uttered the speech; and
in response to not detecting that the mouth movement of the wearer occurred while the speech was detected, determining that the wearer did not utter the speech.

5. The non-transitory computer-readable data storage medium of claim 1, wherein determining whether the wearer of the HMD uttered the speech comprises:
detecting, using a sensor of the HMD other than the microphone, whether mouth movement of the wearer occurred while the speech was detected;
in response to detecting that the mouth movement of the wearer occurred while the speech was detected, determining that the wearer uttered the speech; and
in response to not detecting that the mouth movement of the wearer occurred while the speech was detected, determining that the wearer did not utter the speech.

6. The non-transitory computer-readable data storage medium of claim 1, wherein the microphone comprises a microphone array, and determining whether the wearer of the HMD uttered the speech comprises:
detecting, using the microphone array, whether the speech was uttered from a direction of a mouth of the wearer;
in response to detecting that the speech was uttered from the direction of the mouth of the wearer, determining that the wearer uttered the speech; and
in response to detecting that the speech was not uttered from the direction of the mouth of the wearer, determining that the wearer did not utter the speech.

7. The non-transitory computer-readable data storage medium of claim 1, wherein the wearer is determined as having uttered the speech, wherein the processing further comprises:
capturing facial images of the wearer while the speech is detected, using a camera of the HMD, the facial images comprising the viseme corresponding to the phoneme,
and wherein the avatar is rendered to have the viseme corresponding to the phoneme based on both the phoneme within the detected speech and the captured facial images including the viseme.

8. The non-transitory computer-readable data storage medium of claim 7, wherein the processing further comprises:
capturing sensor data while the speech is detected, using one or multiple sensors other than the camera and the microphone of the HMD,
and wherein the avatar is rendered to have the viseme corresponding to the phoneme further based on the captured sensor data.

9. The non-transitory computer-readable data storage medium of claim 7, wherein rendering the avatar comprises:
applying a model to the captured facial images to generate blendshape weights corresponding to a facial expression of the wearer while the wearer uttered the speech;
identifying the phoneme within the detected speech;
modifying the generated blendshape weights based on the identified phoneme; and
rendering the avatar from the modified blendshape weights.

10. The non-transitory computer-readable data storage medium of claim 7, wherein rendering the avatar comprises:
applying a first model to the captured facial image to generate first blendshape weights corresponding to a facial expression of the wearer while the wearer uttered the speech;
applying a second model to the detected speech to generate second blendshape weights corresponding to the facial expression of the wearer while the wearer uttered the speech;
combining the first blendshape weights and the second blendshape weights to yield combined blendshape weights corresponding to the facial expression of the wearer while the wearer uttered the speech; and
rendering the avatar from the combined blendshape weights.

11. The non-transitory computer-readable data storage medium of claim 7, wherein rendering the avatar comprises:
applying a model to the captured facial image and to the detected speech to generate blendshape weights corresponding to a facial expression of the wearer while the wearer uttered the speech; and
rendering the avatar from the blendshape weights.

12. A method comprising:
detecting, by a processor using a microphone, speech including a phoneme;
determining, by the processor, whether a user uttered the speech;
in response to determining that the user uttered the speech, rendering, by the processor, an avatar representing the user to have a viseme corresponding to the phoneme; and
displaying, by the processor, the avatar representing the user.

13. The method of claim 12, wherein the user is determined as having uttered the speech, wherein the method further comprises:
capturing facial images of the user while the speech is detected, by a processor using a camera, the facial images comprising the viseme corresponding to the phoneme,
and wherein the avatar is rendered to have the viseme corresponding to the phoneme based on both the phoneme within the detected speech and the captured facial images including the viseme.

14. A head-mountable display (HMD) comprising:
a microphone to detect speech including a phoneme;
a camera to capture facial images of a wearer of the HMD while the speech is detected; and
circuitry to:
detect whether mouth movement of the wearer occurred while the speech was detected, from the captured facial images; and
in response to detecting that the mouth movement of the wearer occurred while the speech was detected, render an avatar representing the wearer to have a viseme corresponding to the phoneme.

15. The HMD of claim 14, wherein the captured facial images comprise the viseme corresponding to the phoneme,
and wherein the avatar is rendered to have the viseme corresponding to the phoneme based on both the phoneme within the detected speech and the captured facial images including the viseme.
